(19) United States
(12) Patent Application Publication
(10) Pub. No.: US 2001/0032107 A1
(43) Pub. Date: Oct. 18, 2001

(54) Method and system of data analysis and recording medium

(76) Inventors: Seiji Iwata, Hachioji-shi (JP); Rumi Hayakawa, Yokohama-shi (JP); Kyoko Makino, Yokohama-shi (JP); Yuu Fukada, Kawasaki-shi (JP); Miyoko Miyoshi, Yokohama-shi (JP); Takeshi Izawa, Matsudo-shi (JP); Chihiro Takahashi, Tokyo (JP); Motomu Ootawa, Tokyo (JP); Kazuhide Sato, Chiba-shi (JP); Shinichi Hatano, Chiba-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/789,545

(22) Filed: Feb. 22, 2001

(30) Foreign Application Priority Data
Feb. 23, 2000 (JP) 2000-046411
Feb. 15, 2001 (JP) 2001-038649

(51) Int. Cl. G06F 17/60

(52) U.S. Cl. 705/7; 705/16

(57) ABSTRACT

Of data for analysis of phenomena such as POS analysis data and data of analysis of causes such as question & answer survey result associated with a state in which the data for analysis of phenomena has been acquired, data specified by an initial output specification is output. Then, when a user inputs an associated data output specification, data associated with output data, of the data for analysis of phenomena and data for analysis of causes, is output.

### CROSS-REFERENCE TO RELATED APPLICATIONS

This application is based upon and claims the benefit of priority from the prior Japanese Patent Applications No. 2000-046411, filed Feb. 23, 2000; and Japanese Patent Application No. 2001-038649, filed Feb. 15, 2001, the entire contents of which are incorporated herein by reference.

### BACKGROUND OF THE INVENTION

The present invention relates a method and system of data analysis and a recording medium for assisting analysis and management of data used for, for example, corporation management strategy planning, product sales strategy planning, product management, customer management or the like.

A company performs a variety of analysis and management works such as management strategy planning, product sales strategy planning, product management, customer management or the like.

A specific example of technique for assisting such analysis and management works will be described below.

A management analysis system disclosed in Jpn. Pat. Appln. KOKAI Publication No. 10-312413 is a technique for generating tables or graphs for performing management analysis based on sales information.

A sales planning assistance method and its system disclosed in Jpn. Pat. Appln. KOKAI Publication No. 10-151234 is a technique for preparing a sales plan by making best use of experience from well skilled personnel based on sales result characteristics such as sales state of individual products, sales component rate, utilization rate.

A trade information center apparatus, customer apparatus, and shop information disclosed in Jpn. Pat. Appln. KOKAI Publication No. 11-143952 is a technique for managing customer's trade information, providing share information at shop, and providing information on a house keeping balance sheet to a customer in order to reduce a burden on question & answer survey performed at shop and to reduce problems in preparation of customer's house keeping balance sheet.

A marketing system disclosed in Jpn. Pat. Appln. KOKAI Publication No. 10-78986 is a technique in which a terminal is set up at home in order to input information concerning purchased products, perform analysis, and provide analysis data to companies.

A marketing system disclosed in Jpn. Pat. Appln. KOKAI Publication No. 11-232330 is a technique for performing analysis for data on history, customers, products, and generating business rules.

A retail shop sales promoting method and system disclosed in Jpn. Pat. Appln. KOKAI Publication No. 10-83484 is a technique for cross-analyzing POS data and marketing data, and extracting elements required for sales promotion or design.

Using the prior art for assisting analysis and management works makes it easy for a user to judge what customers think of products or what kinds of images customers have about products as a result of question & answer survey concerning products, for example.

However, even by using the prior art for assisting analysis and management works, it is not confirmed as to whether or not the contents of user judgment coincide with the actual product sales results based on the question & answer survey result.

Therefore, for example, even if it is found that product T is highly popular in such question & answer survey, it is difficult for user to confirm that the number of the sales of such product T has increased.

In addition, even in the case where an employee reports that products are sold well or is popular among customers, it is difficult for user to grasp whether or not such products actually are sold well or are actually popular among customers in the prior art of assisting analysis and management works.

Further, conventionally, analysis has been carried out on what kinds of products are sold well among what kinds of customers or how is the monthly sales based on sales result, customer information or product information. However, it is difficult for a user to analyze why such products are sold well or why such products are not sold.

Specifically, a management analysis system disclosed in Jpn. Pat. Appln. KOKAI Publication No. 10-312413 merely generates tables or graphs for the user to perform analysis. Therefore, the user must analyze causes of the generated result. However, such analysis of causes is difficult.

In a sales planning assistance method and its system disclosed in Jpn. Pat. Appln. KOKAI Publication No. 5-151234, a sales plan is prepared by making best use of experience from well skilled personnel. However, in this invention, analysis of sales information is merely performed, and the cause why a product is sold well is not analyzed.

A trade information center apparatus, customer apparatus, and shop information disclosed in Jpn. Pat. Appln. KOKAI Publication No. 11-143952 provides share information to shops, and provides information on house keeping balance sheet to customers. However in this invention, data provided to shops is limited to share information, and the cause why a product is sold well or the cause why customers think of the product is not analyzed.

In a marketing system disclosed in Jpn. Pat. Appln. KOKAI Publication No. 10-78986, a terminal is set up at each home in order to input information concerning purchased products, perform analysis, and provide the analysis result to companies. However, information acquired in this invention is limited to information on what the customer bought, and the cause why the customer bought such products is not analyzed.

A marketing system disclosed in Jpn. Pat. Appln. KOKAI Publication No. 11-232330 generates a business rule. However, this business rule is merely generated based on quantitative information, and customer's impression or the like is not reflected.

A retail shop sales promoting method and system disclosed in Jpn. Pat. Appln. KOKAI Publication No. 10-83484 cross-analyzes POS data and marketing data, and extracts elements required for sales promotion or design. However, the validity of the cross analysis result is not verified. In addition, the marketing data in this invention does not contain question & answer survey result or the like for customers, and analysis of causes is not performed.

In summarizing the foregoing fact, in the prior art of assisting analysis and management works, data for analysis of causes such as customer's impression or report from employees effective for planning management strategy or sales and customer strategy and, data for analysis of phenomena such as quantitative data, are separate. Therefore, it is difficult for a user to grasp what is the cause of the result obtained by analyzing phenomena that occurred.

### BRIEF SUMMARY OF THE INVENTION

It is an object of the present invention to provide a method and system of data analysis and a recording medium for performing analysis in combination with data for analysis of phenomena and data for analysis of causes.

According to a first aspect of the present invention, there is provided a data analysis method comprising the steps of:

outputting data specified by initial output specification, of at least one item of data for analysis of phenomena and at least one item of data for analysis of causes associated with a state in which the data for analysis of phenomena has been acquired; and

outputting data associated with output data of at least one item of data for analysis of phenomena and at least one item of data for analysis of causes when a user inputs associated data output specification.

In the first aspect of the present invention, in the case where data for analysis of one phenomenon or data for analysis of causes is obtained, there can be output data for analysis of phenomena or data for analysis of causes associated with such acquired data. Therefore, a user can specify the causes of data or support the contents of analysis easily.

Initial output specification may be arbitrarily performed by a user or may be preset as a default.

In addition, data can be output to a printer or display, for example.

Output may be repeatedly performed between data for analysis of phenomena and data for analysis of causes to be switched to each other or may be repeatedly performed between items of data for analysis of phenomena, or between items of data for analysis of causes.

Data may be associated with each other by using information such as date & time, responsible person ID, or product ID. In this case, information for association may be automatically extracted from data for analysis of phenomena and data for analysis of causes based on data items such as date & time, responsible person ID, or product ID.

According to a second aspect of the present invention, there is provided a data analysis method comprising the steps of:

outputting data specified by initial output specification, of at least one item of data for analysis of phenomena and at least one item of data for analysis of causes associated with a state in which such data for analysis of phenomena has been acquired;

extracting identification information on data associated with output data, of at least one item of data for analysis of phenomena and at least one item of data for analysis of causes, and outputting a menu configured based on the thus extracted identification information; and

outputting data indicated by identification information specified by a user, of at least one item of data for analysis of phenomena and at least one item of data for analysis of causes.

In the second aspect of the present invention, a similar effect can be obtained by operation similar to that in the first aspect of the present invention. In addition, even in the case where a number of items of data are associated with output data, data according to the user's request can be output to the user.

The above mentioned information for association is displayed on a menu so that the user may perform analysis while making a selection using this menu.

In addition, keyword search, for example, can be used as a technique for searching the corresponding data for analysis of phenomena or data for analysis of causes from identification information. That is, the above mentioned information for association or the like can be used for identification information.

According to a third aspect of the present invention, there is provided a data analysis method similar to that in the first aspect of the present invention, wherein data for analysis of phenomena and data for analysis of causes associated with each other are displayed to be superimposed on each other when they are displayed and output. In this manner, phenomena and causes of such phenomena can be analyzed from a variety of viewpoints while quantitative data and qualitative data are compared with each other, which are different from each other in characteristics.

With respect to the second aspect of the present invention as well, data for analysis of phenomena and data for analysis of causes may be displayed to be superimposed on each other when they are displayed and output.

According to a fourth aspect of the present invention, there is provided a data analysis method using a computer system.

This method according to the fourth aspect of the present invention comprises the steps of:

Inputting, by a user, a specification of outputting either of at least one item of POS analysis data and at least one item of consumer survey data obtained from the result of a question & answer survey concerning a state in which such POS analysis data is acquired;

acquiring and outputting specified data of at least one item of POS analysis data and at least one item of consumer survey data; and

inputting, by a user, a specification of newly outputting data associated with output data; and

acquiring and outputting newly specified data of at least one item of POS analysis data and at least one item of consumer survey data.

In this manner, in the case where a user wants to know the cause in which the output POS analysis data is obtained, the user can search for the consumer survey data associated with the POS analysis data.

Contrary, in the case where a user wants to know sales result in a state in which the output consumer survey data is obtained, the user can search for POS analysis data associated with such consumer survey data, and output the data.

Therefore, phenomena or causes of such phenomena can be analyzed from a variety of viewpoints by using quantitative data and qualitative data, which are different from each other in characteristics, and can be efficiently used for corporation management strategy planning, product sales strategy planning, product management, customer management and the like.

According to a fifth aspect of the present invention, there is provided a data analysis method similar to that in the fourth aspect of the present invention, wherein, in the case where a user inputs a specification of newly outputting data, identification information on data associated with the output data is output, thereby assisting user input.

Therefore, in the fifth aspect of the present invention, there can be achieved an effect that, even if a number of items of data are associated with output data, a user can acquire his or her desired data easily, and the user's analysis burden can be reduced.

According to a sixth aspect of the present invention, there is provided a data analysis system comprising:

initial output processing unit for executing a processing of outputting data specified by an initial output specification, of at least one item of data for analysis of phenomena and at least one item of data for analysis of causes associated with a state in which such data for analysis of phenomena has been acquired; and

associated output processing unit for, when a user inputs an associated data output specification, executing a processing of outputting data associated with output data, of at least one item of data for analysis of phenomena and at least one item of data for analysis of causes.

According to a seventh aspect of the present invention, there is provided a data analysis system comprising:

initial output processing unit for executing a processing of outputting data specified by an initial output specification, of at least one item of data for analysis of phenomena and at least one item of data for analysis of causes associated with a state in which such data for analysis of phenomena has been acquired;

menu output processing unit for extracting identification information on data associated with output data, of at least one item of data for analysis of phenomena and at least one item of data for analysis of causes, and executing a processing of outputting a menu configured based on the thus extracted identification information; and

associated output processing unit for executing a processing of outputting data indicated by identification information specified by a user, of at least one item of data for analysis of phenomena and at least one item of data for analysis of causes.

According to an eighth aspect of the present invention, there is provided a data analysis system similar to that in the sixth aspect of the present invention, wherein associated output processing unit executes a processing of displaying data for analysis of phenomena and data for analysis of causes associated with each other to be superimposed on each other when they are displayed and output.

With respect to the seventh aspect of the present invention as well, the data for analysis of phenomena and data for analysis of causes may be displayed to be superimposed on each other when they are displayed and output.

According to the sixth to eighth aspects of the present invention, there are provided a data analysis system for carrying out the data analysis method according to the first to third aspect of the present invention, wherein a similar effect can be achieved by operation similar to that in the first to third aspects of the present invention.

A data analysis system according to a ninth aspect of the present invention comprises:

phenomenon analysis processing unit for acquiring at least one item of data for analysis of phenomena;

cause analysis processing unit for acquiring at least one item of data for analysis of causes;

associated analysis processing unit for obtaining an item associated with the contents specified by a user based on associated information indicating association with at least one item of data for analysis of phenomena and at least one item of data for analysis of causes; and

output processing unit for executing a processing of outputting an item associated with the contents specified by a user by using the associated analysis processing unit, phenomenon analysis processing unit, and cause analysis processing unit.

According to a tenth aspect of the present invention, there is provided a data analysis system similar to that in the ninth aspect of the present invention, wherein output processing unit outputs identification information of an item associated with the contents specified by a user to assist user specified input.

According to the ninth and tenth aspects of the present invention, quantitative data, or quantitative data associated with the qualitative data, or qualitative data can be output by user specification. In addition, quantitative data and qualitative data can be compared to be analyzed from a variety of viewpoints. In the ninth and tenth aspects of the present invention, identification information on associated data is output so as to facilitate user operation.

A program for achieving the data analysis method described according to the first to fifth aspects of the present invention by using a computer may be recorded in a recording medium.

A program for achieving the function of the data analysis system described according to the sixth to tenth aspects of the present invention by using a computer may be recorded in a computer readable recording medium.

By employing a recording medium for storing such program, the above mentioned functions can be easily added to a computer, database system or data analysis system that does not have the above mentioned function.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram depicting a configuration example of a data analysis system according to the present invention;

FIG. 2 is a flowchart of analysis processing according to the data analysis system;

FIG. 3 is a block diagram depicting a specific application example of the data analysis system;

FIG. 4 is a block diagram depicting a relationship between data in the data analysis system;

FIG. 5 is a view exemplifying a first transition state of data display in the data analysis system;

FIG. 6 is a view exemplifying a second transition state of data display in the data analysis system;

FIG. 7 is a view exemplifying a third transition state of data display in the data analysis system;

FIG. 8 is a block diagram exemplifying a transition of a screen of the data analysis system;

FIG. 9 is a view showing a top screen as a marketing assistance system;

FIG. 10 is a view showing a top screen for consumer survey report;

FIG. 11 is a view showing a display condition setting screen for displaying the degree of a menu attention and preference;

FIG. 12 is a view showing a four-phase graph display screen for displaying the degree of a menu attention and preference;

FIG. 13 is a view showing a reason comment display screen obtained from the Question & Answer survey result;

FIG. 14 is a view showing an answerer's characteristics display screen for displaying answerer's characteristics;

FIG. 15 is a view showing a display condition setting screen for displaying the degree of attention and preference;

FIG. 16 is a view showing a variation graph display screen indicating variation in the degree of attention and preference;

FIG. 17 is a view showing a POS & survey display screen for displaying POS analysis data and consumer survey data in a superimposed manner;

FIG. 18 is a view showing a top screen of POS analysis data;

FIG. 19 is a view showing a display condition setting screen for displaying a change in amount of sales;

FIG. 20 is a view showing a POS graphic display screen indicating POS analysis results; and

FIG. 21 is a table configuration view of data used in the data analysis system.

### DETAILED DESCRIPTION OF THE INVENTION

Hereinafter, preferred embodiments of the present invention will be described with reference to the accompanying drawings.

### First Embodiment

The present embodiment describes a data analysis system for displaying mutually associated data of data for analysis of phenomena specifying phenomena that occurred and data for analysis of causes concerning the phenomena.

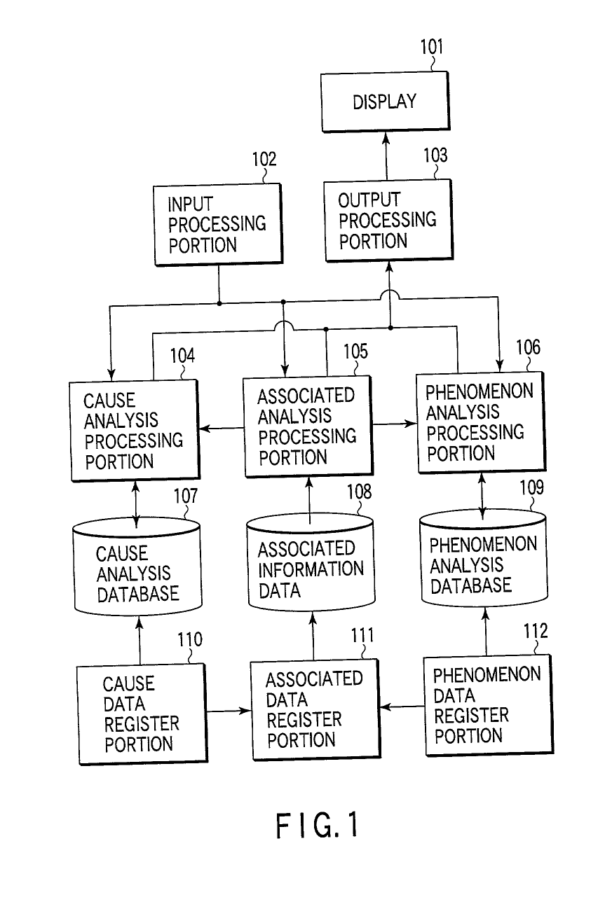

FIG. 1 is a block diagram depicting a configuration example of a data analysis system according to the present embodiment.

A cause data register portion 110 registers input data for analysis of causes in a database 107 for analysis of causes, and outputs data for analysis of causes to an associated data register portion 111.

A phenomenon data register portion 112 registers input data for analysis of phenomena in a database 109 for analysis of phenomena, and outputs data for analysis of phenomena to an associated data register portion 111.

The associated data register portion 111 extracts associated information on each item of data based on the input data for analysis of causes and data for analysis of phenomena, and generates associated information data 108.

An associated analysis processing portion 105 refers to associated information data 108 in accordance with an instruction from an input processing portion 102, and outputs an item concerning the contents instructed from the input processing portion 102 to an output processing portion 103.

In addition, this associated analysis processing portion 105 instructs one or both of the cause analysis processing portion 104 and phenomenon analysis processing portion 106 to execute analysis processing relevant to an associated item in accordance with an instruction from the input processing portion 102.

The cause analysis processing portion 104 executes cause analysis processing based on the instruction from the input processing portion 102 or associated analysis processing portion 105, and outputs the result to the output processing portion 103.

The phenomena analysis processing portion 106 executes phenomena analysis processing based on the instruction from the input processing portion 102 or associated analysis processing portion 105, and outputs the result to the output processing portion 103.

The output processing portion 103 executes processing for displaying the contents input from each of the processing portions 104 to 106 on a display 101.

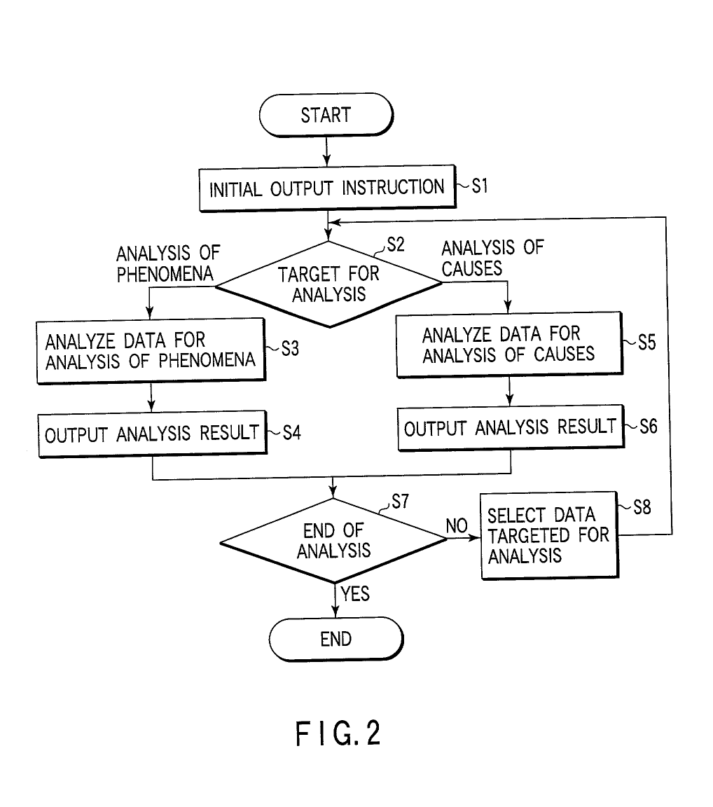

FIG. 2 is a flowchart of analysis processing using the data analysis system according to the present embodiment.

First, a user inputs an initial output instruction (S1), and it is judged whether data targeted for analysis indicated by such initial output instruction corresponds to data for analysis of phenomena or data for analysis of causes (S2).

In the case where data targeted for analysis corresponds to data for analysis of phenomena, the analysis of the data for analysis of phenomena is executed (S3), and the analysis result is output (S4).

On the other hand, in the case where data targeted for analysis corresponds to data for analysis of causes, the analysis of the data for analysis of causes is executed (S5), and the analysis result is output (S6).

Then, it is judged whether analysis is repeated or terminated (S7). In the case where analysis is repeated, the next data targeted for analysis is selected (S8), and the subsequent processing for judgment of data targeted for analysis is repeated.

Now, a specific application example of the data analysis system according to the present embodiment will be described below.

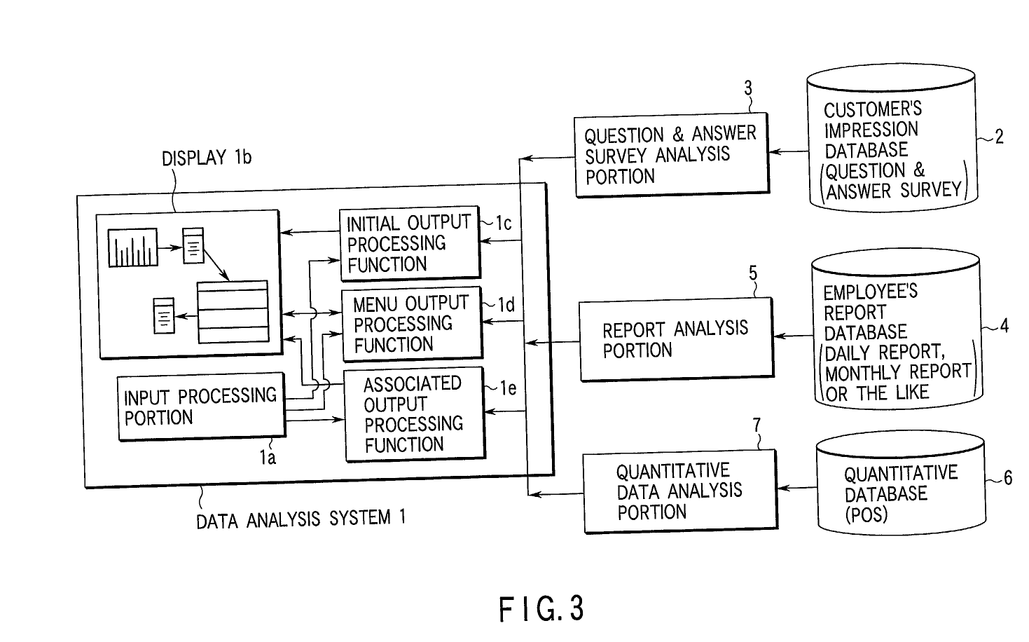

FIG. 3 is a block diagram depicting a specific application example of the data analysis system according to the present embodiment.

A data analysis system 1 acquires the question & answer analysis result that is the analysis result of a question & answer survey analysis portion 3 (corresponding to a cause analysis processing portion 104) based on the contents of a customer impression database 2 (corresponding to a cause analysis database 107) for registering customer's impressions acquired by a question & answer survey. For example, the question & answer survey analysis portion 3 provides the customer's importance and satisfaction relevant to products.

In addition, the data analysis system 1 acquires the report analysis result that is the analysis result of a report analysis portion 5 (corresponding to the cause analysis processing portion 104) based on the contents of an employee report database 4 (corresponding to a cause analysis database 107) for registering the employee's report such as daily report, monthly report, and annual report. For example, the report analysis portion 5 recognizes the reporter, report time, report contents concerning each report.

Further, the data analysis system 1 acquires the quantitative data analysis result that is the analysis result of a quantitative data analysis portion 7 (corresponding to a phenomenon analysis processing portion 106) based on the contents of a quantitative database 6 (phenomenon analysis database 112) for registering quantitative data acquired by a POS system.

For example, the quantitative data analysis portion 7 can provide sales data on a certain time of a certain product.

The data analysis system 1 comprises an input processing portion 1a (corresponding to an input processing portion 102) for inputting a user's instruction and a display 1b (corresponding to a display 101). This system further comprises: an initial output processing function 1c (corresponding to an output processing portion 103); a menu output processing function 1d (corresponding to the output processing portion 103 and an associated analysis processing portion 105); and an associated output processing function 1e (corresponding to the output processing portion 103).

When the data analysis system 1 executes the initial output processing function 1c, data preset or user specified by an initial output specification at the input processing portion 1a is input from any of the question & answer survey analysis portion 3, report analysis portion 5, and quantitative data analysis portion 7, and is displayed on the display 1b.

The data analysis system 1 executes the menu output processing function 1d when the input processing portion 1a inputs a menu output instruction. If there exists data associated with the data displayed on the display 1b, the identification information on this data is input from at least one of the question & answer survey analysis portion 3, report analysis portion 5, and quantitative data analysis portion 7. Then, a menu is created by this identification information and displayed on the display 1b.

Here, it is judged as to whether data is associated with each other depending on the attributes of each data such as identical time information, product, shop, or regional information.

Table 1 shows a relation between data items. As shown in Table 1, attributes such as the time, product, shop and the like are registered in association with each of the question & answers 1 to 3, i.e., qualitative data items. As shown in Table 1, too, attributes such as the time, product, shop and the like are registered in association with each of the POS data 1 to 4, i.e., quantitative data items. Table 1 is registered as associated information data 108.

The user may observe the POS data (i.e., the data for analysis of phenomenon) about the sales of the television set in December 1999, finding that the sales of the television set has increased in the Osaka shop. To demand a research for the cause of the sales increase, the user inputs a request for the research, to the input processing portion 102.

The menu output processing function 1d (chiefly, the associated analysis processing portion 105) extracts from the associated information data 108 the question & answer 1, or data for use in analyzing the cause, in accordance with the attributes of the POS data (i.e., time: December 1999; product: television set; shop: Osaka).

The menu output processing function 1d (mainly, the output processing portion 103) supplies the data (i.e., the question & answer 1) to the display 101. The display 101 display the data for use in analyzing the cause.

The kinds of attributes shown in Table 1, the number of question & answers registered, and the POS data items registered can be changed freely.

TABLE 1

| | Time | Product | Shop |
|---|---|---|---|
| Question & answer 1 | December, 1999 | Television | Osaka |
| | | set | |
| Question & answer 2 | January, 2000 | Stereo Set | Tokyo |
| Question & answer 3 | January, 2000 | DVD | Tokyo |
| POS data 1 | December, 1999 | Television | Tokyo |
| | | set | |
| POS data 2 | December, 1999 | Television | Osaka |
| | | set | |
| POS data 3 | December, 1999 | Television | Yokohama |
| | | set | |
| POS data 4 | January, 2000 | Stereo Set | Tokyo |

In addition, when the input processing portion 1a inputs any specification of identification information from a menu, the data analysis system 1 inputs data indicating the identification information specified by the associated output processing function 1e from any of the question & answer survey analysis portion 3, report analysis portion 5, and quantitative data analysis portion 7, and displays the data on the display 1b.

When there does not exist any associated data, this data analysis system 1 displays the fact.

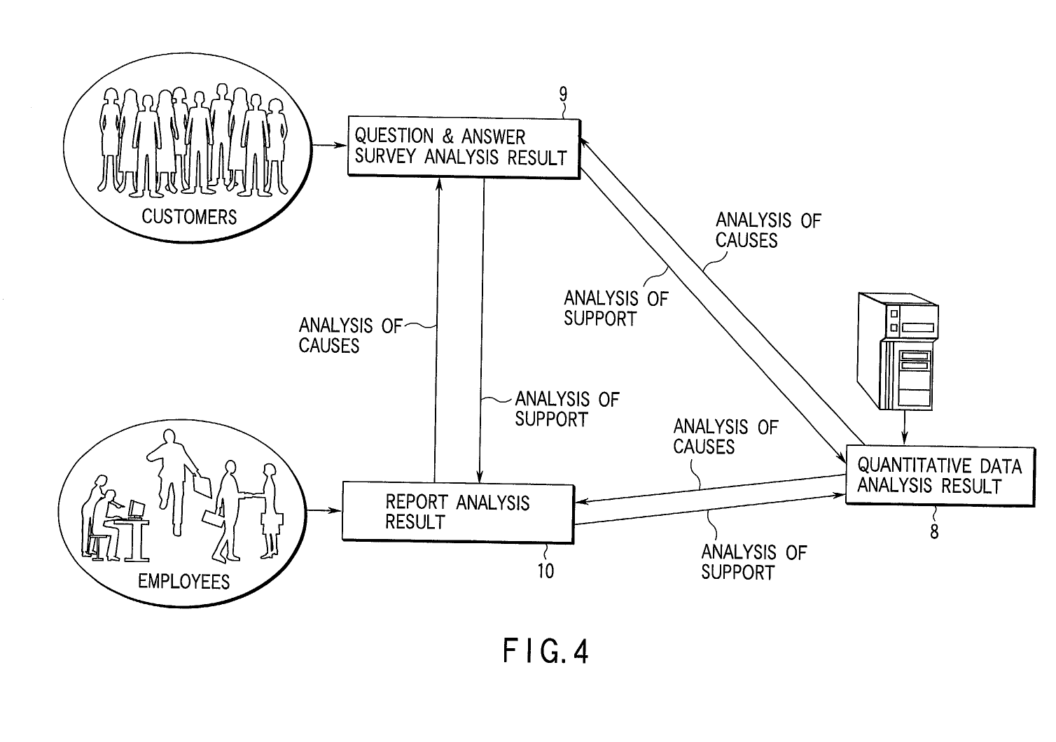

FIG. 4 is a block diagram depicting a relationship in data on the data analysis system 1 according to the present embodiment.

In this data analysis system 1, when a quantitative data analysis result 8 is defined as data for analysis of phenomena, data for analysis of causes relevant to the quantitative data analysis result corresponds to a question & answer survey analysis result 9 and a report analysis result 10.

In addition, when the report analysis result 10 is defined as data for analysis of phenomena, data for analysis of causes relevant to the report analysis result 10 corresponds to the question & answer survey analysis result 9.

For example, in the case where a user attempts to analyze the cause of the quantitative data analysis result 8, the data analysis system 1 displays the question & answer survey analysis result 9 or report analysis result 10 associated with the quantitative data analysis result 8.

On the other hand, in the case where a user attempts to support the question & answer survey analysis result 9 or report analysis result 10, the data analysis system 1 displays the quantitative data analysis result 8 associated with the question & answer survey analysis result 9 or report analysis result 10.

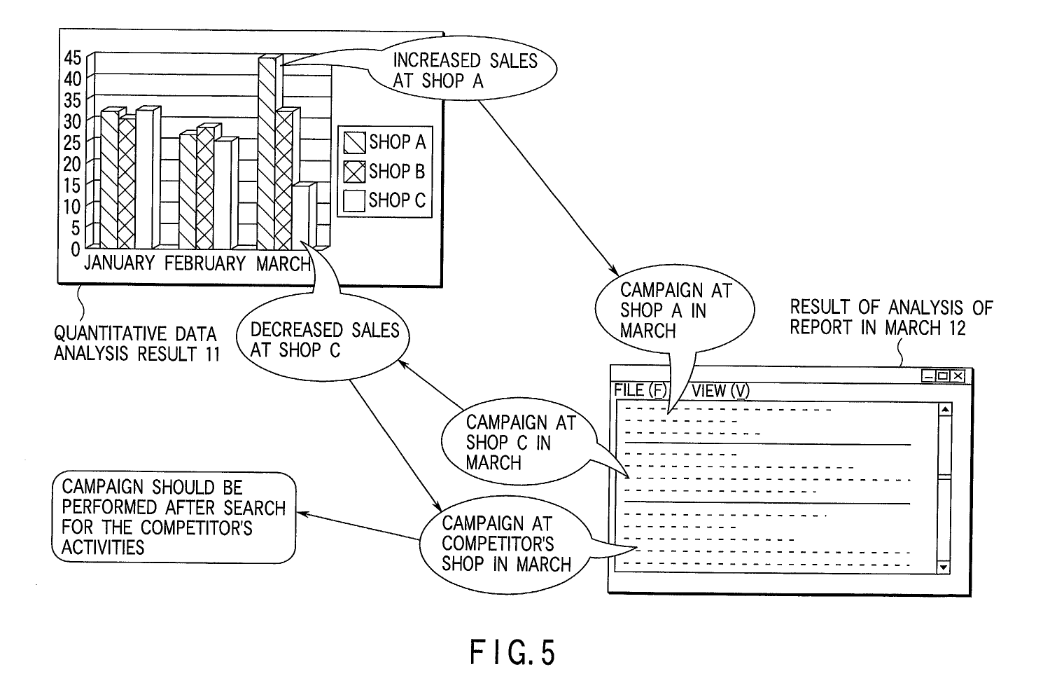

FIG. 5 is a view exemplifying a first transition state of data display in the data analysis system 1 according to the present embodiment.

For example, when a quantitative data analysis result 11 concerning monthly sales of shops A to C is displayed on the display 1b, assume that a user grasp that the sales of shop A in March increases.

Then, the user clicks the sales of the shop A in March with the mouse, and makes a selection for displaying the report analysis result in March on a menu.

Then, the contents of the report analysis result 12 in March are displayed on the display 1b, and the user obtains a report that a campaign has been performed at shop A in March.

Here, when the contents of the report analysis result 12 in March is studied, assume that a campaign has been performed at shop C in March.

The user displays the quantitative data analysis result 11 on the display 1b, and confirms the sales of shop C in March. In this way, it is found that sales decrease at shop C, although a campaign has been performed.

Then, when the user displays the report analysis result 12 in March on the display 1b, and studies the contents, the user obtains a report that campaign has been performed at the competitor's shops in March.

In this manner, the user obtains a conclusion that, in the case of performing a campaign, it is effective to search for the competitor's activities.

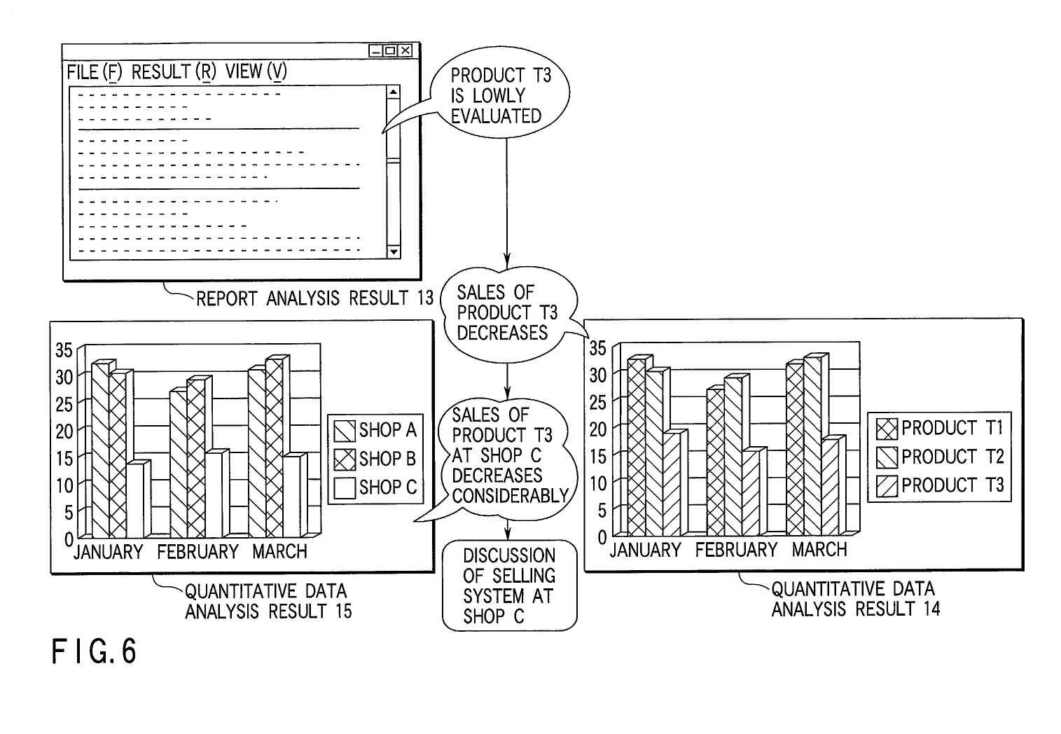

FIG. 6 is a view exemplifying a second transition state of data display in the data analysis system 1 according to the present embodiment.

For example, assume that the user displays the report analysis result 13 on the display 1, and finds a report that product T3 is evaluated to be low.

Then, the user clicks the product T3 of the report analysis result 13 with the mouse, and makes a selection for displaying monthly sales on products T1 to T3 from a menu.

Then, as the quantitative data analysis result 14, the monthly sales on products T1 to T3 are displayed on the display 1b, and the user finds that the sales of product T3 is lower than those of the other products T1 and T2.

Here, the user clicks the sales on the product T3 with mouse, and makes a selection for displaying the monthly sales on product T3 at shops A to C from a menu.

Then, as the quantitative data analysis result 15, the monthly sales on product T3 at shops A to C are displayed on the display 1b, and the user finds that the sales of product T3 is lower at shop C.

In this manner, the user obtains a conclusion that there may be a problem with how to sell the product T3 at shop C or product T3 should not be sold at shop C.

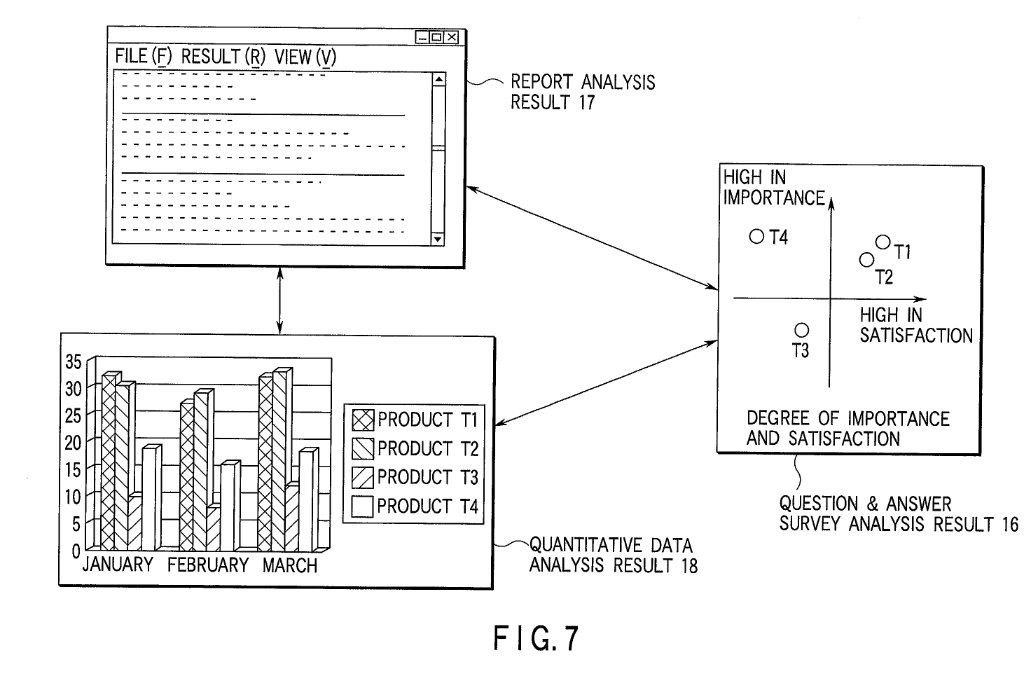

FIG. 7 is a view exemplifying a third transition state of data display in the data analysis system 1 according to the present embodiment.

Here, as the question & answer analysis result 16, the importance and satisfaction of each of the products T1 to T4 are displayed on the display 1b. In the data analysis system 1, the current display can be switched to the other analysis results 17 and 18 associated with the question & answer survey analysis result 16.

As has been described above, when the data analysis system 1 according to the present embodiment is used, the user can perform analysis, freely referring to the mutually associated quantitative data analysis result, question & answer survey analysis result, and report analysis result.

Therefore, the user can perform analysis of causes or support of the analyzed contents easily, and high-level, effective information can be provided.

In addition, a menu of the analysis results associated with the displayed contents is presented so that the user can display arbitrary associated analysis results on the display 1b by using this menu.

Therefore, even if there exist a number of items of associated data, the user can display the analysis results according to his or her own request, whereby higher level, effective information can be provided to the user.

### Second Embodiment

In the data analysis system 1 described in the first embodiment, a variety of data for analysis of phenomena and data for analysis of causes can be used, and a variety of analyses can be performed.

Tables 2 to 5 each exemplify an object of using the data analysis system 1; data for analysis of causes and data for analysis of phenomena used for analysis; display transition direction; specific contents of analysis of causes; and specific contents of analysis of phenomena. Tables 2 to 5 each exemplify a case of analysis of product sales.

TABLE 2

| | | | | | | SPECIFIC |
|---|---|---|---|---|---|---|
| | | DATA ON | DATA ON | | | CONTENTS |
| | OBJECT OF | ANALYSIS | ANALYSIS OF | SPECIFIC CONTENTS OF | | OF ANALYSIS |
| | SYSTEM USE | OF CAUSES | PHENOMENA | ANALYSIS OF CAUSES | TRANSITION | OF CAUSES |
| 1 | <SHOP OF | QUESTION & | CUSTOMER | <1> WHY DO CUSTOMERS | ← | ANALYSIS OF |
| | COMPANY A> | ANSWER SURVEY | DATABASE | WHO DO NOT VISIT | | CHARACTERISTICS |
| | CHARACTERISTICS | RESULT | PRODUCT | COMPANY A BUY | | OF SALES |
| | OF SALES AT SHOP | | DATABASE | SOMETHING AT A | | CONTENTS OF |
| | ARE ANALYZED BY | | SALES RESULT | COMPETITOR'S SHOP? | | COMPANY A |
| | USING CUSTOMER | | DATABASE | <2> WHAT DO CUSTOMERS | | A) ANALYSIS OF |
| | DATA, SALES DATA | | | WHO DO NOT VISIT | | SALES BY SHOP |
| | OR THE LIKE, AND | | | DEPARTMENT STORE A | | B) ANALYSIS OF |
| | THE CAUSES ARE | | | FEEL ATTRACTIVE AT | | SALES BY REGION |
| | ANALYZED BY | | | A COMPETITOR'S SHOP? | | C) ANALYSIS OF |
| | QUESTION & ANSWER | | | <3> WHY DO CUSTOMERS | | SALES BY AGE |
| | SURVEY RESULT | | | VISIT DEPARTMENT | | OR GENDER |
| | | | | STORE A? | | D) RFM ANALYSIS |
| | | | | <4> WHAT DO CUSTOMERS | | |
| | | | | WHO VISITS DEPARTMENT | | |
| | | | | STORE A FEEL | | |
| | | | | ATTRACTIVE AT SHOP? | | |

TABLE 3

| | | DATA ON | DATA ON | | | |
|---|---|---|---|---|---|---|
| | OBJECT OF SYSTEM | ANALYSIS | ANALYSIS OF | SPECIFIC CONTENTS OF | | SPECIFIC CONTENTS OF |
| | USE | OF CAUSES | PHENOMENA | ANALYSIS OF CAUSES | TRANSITION | ANALYSIS OF PHENOMENA |
| 1 | SUPPORT FOR | DAILY | POS | <1> INCREASED SALES | → | A) ANALYSIS OF PRODUCT |
| | SUBJECTIVE REPORT | REPORT | INFORMATION | OF PRODUCT A | | SALES BY SHOP |
| | CONTENTS OF SALES | DATA | | <2> BLUNTED SALES OF | | B) ANALYSIS OF PRODUCT |
| | PERSONNEL | | | PRODUCT B | | SALES BY AGE AND/OR |
| | CHECKING | | | <3> HIGH REPUTATION | | CUSTOMER |
| | ANALYSIS RESULT | | | OF PRODUCT C AMONG | | C) ANALYSIS OF PRODUCT |
| | OF DAILY REPORT | | | WOMEN | | SALES BY REGION |
| | DATA USING POS | | | | | D) ANALYSIS OF PRODUCT |
| | INFORMATION | | | | | SALES BY MONTH OR |
| | | | | | | WEEK |
| 2 | ANALYSIS OF | QUESTION | CUSTOMER | <1> SURVEY ON | ← | ANALYSIS BEFORE AND |
| | EFFECT OF | & ANSWER | DATABASE | CUSTOMER'S | | AFTER CAMPAIGN |
| | CAMPAIGN | SURVEY | PRODUCT | IMPRESSION ON | | A) ANALYSIS OF PRODUCT |
| | PERFORMED FOR | RESULT | DATABASE | PRODUCTS BEFORE AND | | SALES BY AGE AND/OR |
| | THE COMPANY'S | | | AFTER CAMPAIGN | | CUSTOMER |
| | PRODUCTS | | SALES | <2> CUSTOMER'S | → | B) ANALYSIS OF PRODUCT |
| | ANALYSIS OF | | RESULT | EVALUATION OF THE | | SALES BY REGION |
| | CUSTOMER'S | | DATABASE | COMPANY'S PRODUCT | | C) ANALYSIS OF PRODUCT |
| | RESPONSE | | | AGAINST COMPETITOR'S | | SALES BY MONTH AND/ |
| | (QUESTION & | | | ANALOGOUS PRODUCTS | | OR WEEK |
| | ANSWER SURVEY | | | BEFORE AND AFTER | | |
| | RESULT) AND SALES | | | CAMPAIGN | | |
| | RESULT | | | | | |

TABLE 4

| | | | | SPECIFIC | | |
|---|---|---|---|---|---|---|
| | | DATA ON | DATA ON | CONTENTS OF | | SPECIFIC CONTENTS |
| | | ANALYSIS | ANALYSIS OF | ANALYSIS OF | | OF ANALYSIS |
| | OBJECT OF SYSTEM USE | OF CAUSES | PHENOMENA | CAUSES | TRANSITION | OF PHENOMENA |
| 1 | TO KNOW WHY | QUESTION | CUSTOMER | <1> CUSTOMER'S | ← | A) ANALYSIS OF |
| | SPECIFIC PRODUCTS | & ANSWER | DATABASE | EVALUATION AND | | PRODUCT SALES BY |
| | ARE NOT SOLD | SURVEY | PRODUCT | IMPRESSION ON | | SHOP |
| | | RESULT | DATABASE | PRODUCTS | | B) ANALYSIS OF |
| | ANALYSIS OF CAUSES | DAILY | SALES | <2> ANALYSIS OF | → | PRODUCT SALES BY |
| | FOR DECREASED SALES | REPORT | RESULT | DIFFERENCE | | AGE AND/OR |
| | RESULT | DATA | DATABASE | BETWEEN SHOPS | | CUSTOMER |
| | WHETHER OR NOT | | | AT WHICH | | C) ANALYSIS OF |
| | SPECIFIC PRODUCTS | | | PRODUCTS ARE | | PRODUCT SALES BY |
| | ARE NOT SOLD AT | | | SOLD WELL OR | | REGION |
| | SPECIFIC SHOPS OR | | | ARE NOT SOLD | | D) ANALYSIS OF |
| | REGIONS OR WHAT IS A | | | WELL SUCH AS | | PRODUCT SALES BY |
| | DIFFERENCE BETWEEN | | | SHOP STATES | | MONTH AND/OR WEEK |
| | SHOPS AT WHICH SUCH | | | (SHELVING OR | | |
| | PRODUCTS ARE SOLD | | | DISPLAY STATE) | | |
| | WELL OR ARE NOT SOLD | | | | | |
| | WELL | | | | | |

TABLE 5

| | | | | SPECIFIC | | |
|---|---|---|---|---|---|---|
| | | DATA ON | | CONTENTS OF | | SPECIFIC CONTENTS |
| | | ANALYSIS | DATA ON ANALYSIS | ANALYSIS OF | | OF ANALYSIS OF |
| | OBJECT OF SYSTEM USE | OF CAUSES | OF PHENOMENA | CAUSES | TRANSITION | PHENOMENA |
| 1 | WHETHER OR NOT | DAILY | CUSTOMER DATABASE | <1> CUSTOMER'S | → | A) ANALYSIS OF |
| | SALES PROMOTION | REPORT | PRODUCT DATABASE | IMPRESSION ON | | PRODUCTS THAT ARE |
| | ACTIVITIES OF ONE | DATA | SALES RESULT | INDIVIDUAL SHOPS | | SOLD WELL BY SHOP |
| | SHOP IS EFFECTIVE IN | QUESTION | DATABASE | <2> CONTENTS OF | | B) ANALYSIS OF |
| | ANOTHER SHOP | & ANSWER | | SALES PROMOTION | | SALES BY AGE |
| | CHECKING WHETHER OR | SURVEY | | ACTIVITIES | | AND/OR CUSTOMER |
| | NOT ACTIVITIES | RESULT | | PERFORMED BY | | FOR EACH SHOP |
| | PERFORMED BY SALES | | | SALES PERSONNEL | | C) ANALYSIS OF |
| | PERSONNEL AT SHOP A | | | | | SALES BY REGION |
| | IS EFFECTIVE IN | | | | | |
| | ANOTHER SHOP FROM | | | | | |
| | ANALYSIS OF | | | | | |
| | CUSTOMERS AT SHOP OR | | | | | |
| | THE LIKE | | | | | |
| 2 | TO KNOW CUSTOMER'S | DAILY | CUSTOMER DATABASE | <1> CUSTOMER'S | ← | A) ANALYSIS OF |
| | RESPONSE TO NEW | REPORT | PRODUCT DATABASE | EVALUATION OF | | PRODUCT SALES BY |
| | PRODUCTS | QUESTION | SALES RESULT | NEW PRODUCTS | | MONTH AND/OR WEEK |
| | | & ANSWER | DATABASE | <2> CUSTOMER'S | → | B) ANALYSIS OF |
| | | SURVEY | | RESPONSE AT SHOP | | PRODUCT SALES BY |
| | | | | | | AGE AND/OR |
| | | | | | | CUSTOMER |
| | | | | | | C) ANALYSIS OF |
| | | | | | | PRODUCT SALES |
| | | | | | | BY REGION |

Table 6 exemplifies a case of analysis of man-hour of development work, and describes items similar to the above.

TABLE 6

| | | | | | | SPECIFIC |
|---|---|---|---|---|---|---|
| | | DATA ON | DATA ON | SPECIFIC CONTENTS | | CONTENTS OF |
| | | ANALYSIS OF | ANALYSIS OF | OF ANALYSIS OF | | ANALYSIS OF |
| | OBJECT OF SYSTEM USE | CAUSES | PHENOMENA | CAUSES | TRANSITION | PHENOMENA |
| 1 | ANALYSIS OF CAUSES | EMPLOYEE'S | MAN-HOUR DATA | <1> EXTRACTION OF | ← | A) MAN-HOUR |
| | OF WORKS WITH MORE | DAILY REPORT | | ALARM INFORMATION | | ANALYSIS BY |
| | MAN-HOURS CONSUMED | TRANSACTION | | FROM DAILY REPORT | | EMPLOYEE AND |
| | THAN SCHEDULED | OF CONFERENCE | | OR TRANSACTIONS | | PROJECT |
| | | | | (SUCH AS SLOWER | | |
| | | | | DEVELOPMENT OR | | |
| | | | | OCCURRENCE OF | | |
| | | | | PROBLEMS) | | |
| 2 | ANALYSIS OF WORK | EMPLOYEE'S | MAN-HOUR DATA | <1>EXTRACTION OF | ← | A) MAN-HOUR |
| | CONTENTS OF | DAILY REPORT | | THE WORK PERFORMED | | ANALYSIS BY |
| | PERSONNEL WHO WORKS | TRANSACTION | | BY THE EMPLOYEE | | EMPLOYEE AND |
| | TOO MUCH OVERTIME | OF CONFERENCE | | AND ITS STATE FROM | | PROJECT |
| | | | | DAILY REPORT OR | | |
| | | | | TRANSACTIONS | | |
| | | | | AND THE LIKE | | |
| 3 | SUPPORT FOR REPORT | EMPLOYEE'S | MAN-HOUR DATA | <1>EXTRACTION OF | → | ANALYSIS OF |
| | CONTENTS | DAILY REPORT | | PROGRESS IN THE | | MAN-HOURS OF |
| | | TRANSACTIONS | | PROJECT FROM DAILY | | MEMBERS |
| | CHECKING WHETHER, | OF CONFERENCE | | REPORT, | | INVOLVED IN |
| | IF DEVELOPMENT WORK | | | TRANSACTION AND | | THE PROJECT |
| | IS STARTED THIS WEEK | | | THE LIKE | | |
| | IN REPORT, MAN-HOURS | | | | | |
| | ARE ACTUALLY USED | | | | | |
| | FOR SUCH DEVELOP- | | | | | |
| | MENT WORK | | | | | |

Table 7 exemplifies a case of analysis of production results, and describes items similar to the above.

TABLE 7

| | | | | SPECIFIC | | SPECIFIC |
|---|---|---|---|---|---|---|
| | | DATA ON | DATA ON | CONTENTS OF | | CONTENTS OF |
| | OBJECT OF SYSTEM | ANALYSIS OF | ANALYSIS OF | ANALYSIS OF | | ANALYSIS OF |
| | USE | CAUSES | PHENOMENA | CAUSES | TRANSITION | PHENOMENA |
| 1 | ANALYSIS OF | DAILY REPORT | PRODUCTION | ABSENCE OF | ← | THE YIELD OF |
| | CAUSE IF YIELD | | RESULT DATA | SOME MEMBERS | | THIS WEEK ARE |
| | IS LOWERED IN | | | BECAUSE OF | | LOWERED THAN |
| | SEMICONDUCTOR | | | SICKNESS | | THAT OF LAST |
| | PRODUCTION WORKS | | | PREVENTIVE | | WEEK BY 20% |
| | OR THE LIKE | | | MAINTENANCE | | THE YIELDS ARE |
| | | | | AND INSPECTION | | LOWERED |
| | | | | | | CONTINUOUSLY THE |
| | | | | | | LAST THREE WEEKS |
| 2 | HOW CHANGE IN | DAILY REPORT | PRODUCTION | EDUCATION & | → | PRODUCT FAILURE |
| | WORK STATE | | RESULT DATA | TRAINING OF | | RATE INCREASED |
| | INFLUENCES YIELD | | FAILURE | NEW EMPLOYEES | | PRODUCT FAILURE |
| | OR FAILURE RATE | | RATE DATA | IMPROVED WORK | | RATE DECREASED |
| | | | | ENVIRONMENT | | |

Tables 8 and 9 each exemplify a case of analysis of audience share; analysis of traffics; analysis of schedule, and analysis of customer's complaint, and describe items similar to the above.

TABLE 8

| | | | | SPECIFIC | | SPECIFIC |
|---|---|---|---|---|---|---|
| | | DATA ON | DATA ON | CONTENTS OF | | CONTENTS OF |
| | | ANALYSIS | ANALYSIS OF | ANALYSIS OF | | ANALYSIS OF |
| | OBJECT OF SYSTEM USE | OF CAUSES | PHENOMENA | CAUSES | TRANSITION | PHENOMENA |
| 1 | SUPPORT FOR ANALYSIS | USER | AUDIENCE | WHY AUDIENCES | ← | WHAT IS THE |
| | RESULT OF AUDIENCE | QUESTION | SHARE DATA | LOOK AT OR DOES | | TIME ZONE AT |
| | SHARE BY USER QUESTION | & ANSWER | CUSTOMER | NOT LOOK AT | | HIGH |
| | & ANSWER SURVEY | SURVEY | DATA | THAT PROGRAM? | | AUDIENCE SHARE? |
| | | | | WHAT KIND OF | | WHAT IS THE |
| | | | | PROGRAM SHOULD | | ATTRIBUTE OF |
| | | | | BE BROADCAST | | AUDIENCE IN |
| | | | | IN THAT TIME | | THAT TIME |
| | | | | ZONE? | | ZONE? |
| 2 | ANALYSIS OF CAUSES WHY | USER | TRAFFIC | HOLIDAY | ← | ANALYSIS OF |
| | TRAFFIC IS HEAVY IN | QUESTION | CONJUNCTION | PATTERN | | TRAFFIC BY |
| | THAT TIME ZONE RELEVANT | & ANSWER | INFORMATION | | | TIME ZONE |
| | TO THE TRAFFIC AT THE | SURVEY | TRAFFIC | WHY DID THE | | |
| | END OF THE YEAR OR THE | | DATA | USER GO | | |
| | BEGINNING OF THE YEAR | | | THROUGH THAT | | |
| | OR AT S SPECIFIC DATE | | | ROUTE? | | |
| | AND TIME OR RELEVANT TO | | | | | |
| | THE TRAFFIC CONJUNCTION | | | | | |
| | RESULT | | | | | |

TABLE 9

| | | | | | | SPECIFIC |
|---|---|---|---|---|---|---|
| | | DATA ON | DATA ON | | | CONTENTS OF |
| | OBJECT OF | ANALYSIS OF | ANALYSIS OF | SPECIFIC CONTENTS OF | | ANALYSIS OF |
| | SYSTEM USE | CAUSES | PHENOMENA | ANALYSIS OF CAUSES | TRANSITION | PHENOMENA |
| 1 | FLIGHT | USER QUESTION | FLIGHT | WHY DID THE CUSTOMER | ← | RESERVATION |
| | SCHEDULE | & ANSWER | INFORMATION | SELECT THAT AIRWAY? | | RATE BY TIME |
| | PLANNING | SURVEY | CUSTOMER | WHAT DOES THE CUSTOMER | | ZONE OR FLIGHT |
| | AND | FLIGHT MEMBER | INFORMATION | EXPECT? | | ANALYSIS OF |
| | CAMPAIGN | DAILY REPORT | | | | CUSTOMER BY |
| | PLANNING | | | | | TIME ZONE OR |
| | | | | | | FLIGHT |
| 2 | ANALYSIS OF | CONTENTS OF | DATA ON | WHAT DO THE CUSTOMERS | ← | ANALYSIS OF |
| | COMPLAINS | COMPLAINT | COMPLAINTS | EXPECT AGAINST THAT | | COMPLAINTS IN |
| | IN NUMBER | QUESTION & | IN NUMBER | PRODUCT? | | NUMBER BY TIME |
| | IN CUSTOMER | ANSWER SURVEY | CUSTOMER | WHAT KIND OF ACTION | | ZONE OR REGION |
| | CONSULTING | RESULT | DATA | DOES SALES PERSONNEL | | ANALYSIS OF |
| | SYSTEM AND | EMPLOYEE'S | PRODUCT | TAKE WHEN THE NUMBER OF | | COMPLAINTS IN |
| | ANALYSIS OF | DAILY REPORT | DATA | COMPLAINTS INCREASES? | | NUMBER BY |
| | CONTENTS OF | | | IS THERE ANY CHANGE IN | | PRODUCT, AGE, |
| | COMPLAINT | | | STATE OF SHOP WHEN THE | | AND GENDER |
| | | | | NUMBER OF COMPLAINTS | | |
| | | | | INCREASES? | | |

The data analysis system 1 described in each of the embodiments may be changed in disposition of each constituent element as long as the similar operation and function can be achieved or the constituent elements may be freely combined with each other.

In addition, in the present embodiment, although the contents of the present invention is described as the data analysis system 1, the data analysis method implemented in this data analysis system 1 can be defined as the contents of the invention.

In addition, the functions and elements of the data analysis system 1 described in each of the embodiments may be applied as computer executable programs, by being written into a recording medium such as magnetic disk (such as floppy disk or hard disk), optical disk (such as CD-ROM or DVD), or semiconductor memory. In addition, these functions and elements can be applied to a computer, a database system, or a data analysis system by being transmitted via a communication medium.

A computer achieving each of these functions executes the above-mentioned processing by reading a program recorded in a recording medium, and by being operatively controlled by the program.

### Third Embodiment

In the present embodiment, application of the data analysis system 1 described in the first embodiment will be described in detail.

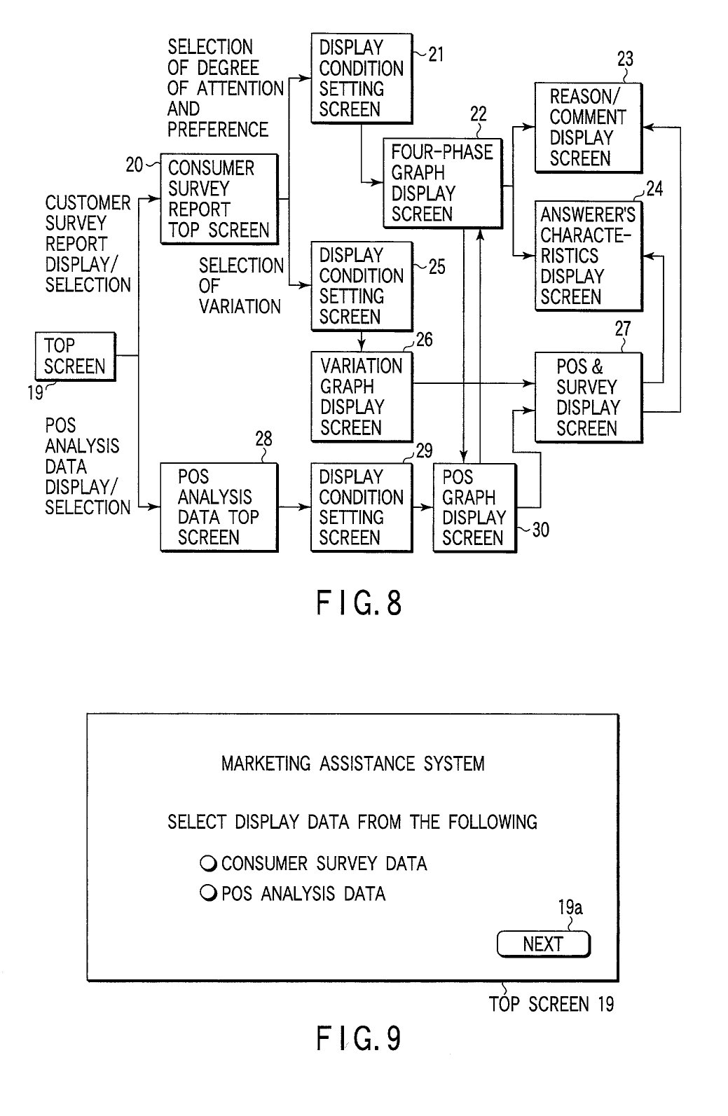

FIG. 8 is a block diagram depicting transition of the screen in the data analysis system 1, wherein screens 19 to 30 and their transition relationship are indicated by the arrows. In addition, the screens 20 to 30 can return to an immediately preceding screen, and can return to a variety of top screens 19, 20 and 28. In FIG. 8, there is shown a case in which the data analysis system 1 is used as a marketing assistance system. A target for marketing is an eating house ABCD having a plurality of shops. Data handled in this marketing assistance system is consumer survey data (qualitative data) obtained as a result of POS analysis data (qualitative data) and a question & answer survey.

First, in the case of using the marketing assistance system, the top screen 19 as shown in FIG. 9 is displayed. On this top screen 19, the user specifies a display “consumer survey data” or a display “POS analysis data”, and press a “next” button 19a.

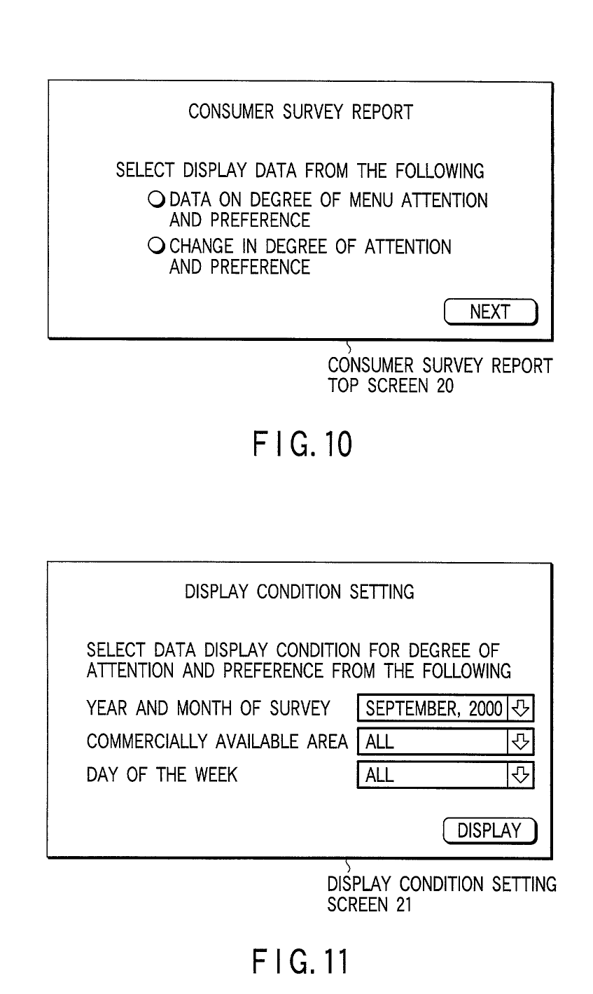

Here, assume that the user selects a display “consumer survey data”. In this case, a consumer survey report top screen 20 shown in FIG. 10 is displayed. On this consumer survey report top screen 20, the user specifies a display “data on degree of menu attention and preference” or a display “change in degree of attention and preference”.

When the user select a display “data on degree of menu attention and preference”, a display condition setting screen 21 shown in FIG. 11 is displayed. The user selects the display conditions by using a pull-down list on this display condition setting screen 21. A default value is set in the pull-down list in which the user has not made any selecting operation.

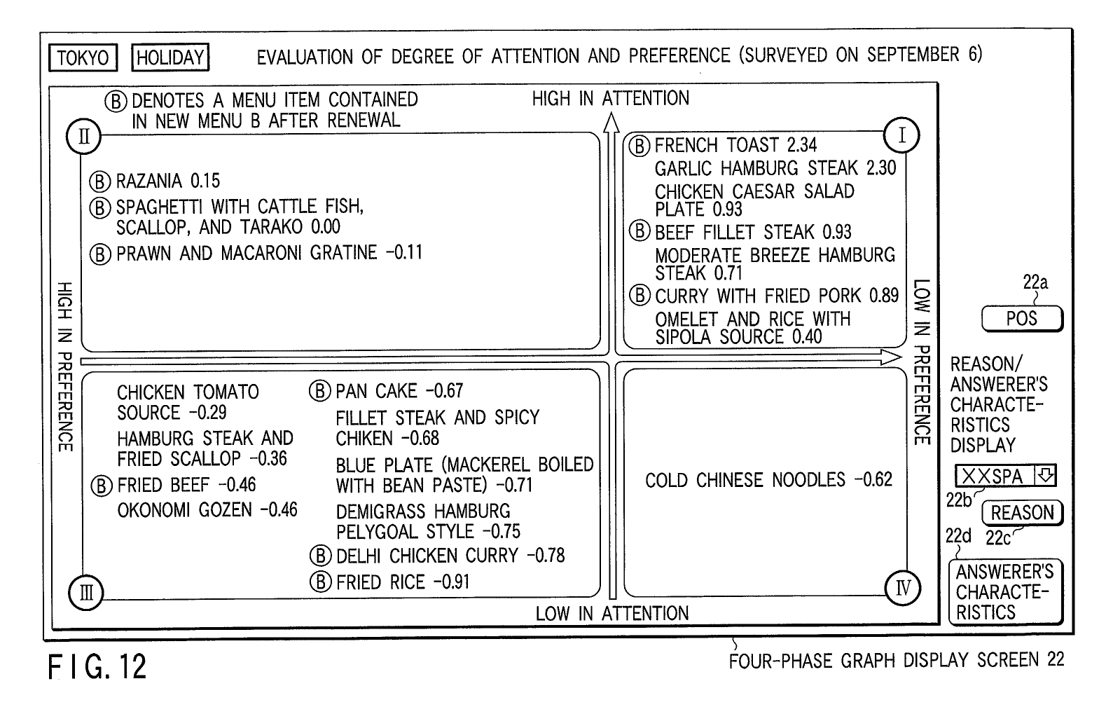

Then, a four-phase graph display screen 22 as shown in FIG. 12 is displayed in accordance with the display conditions.

On the four-phase graph display screen 22, there is displayed a four-phase graph expressed on an axis indicating the degree of attention and an axis indicating the degree of preference. On this four-phase graph, a variety of menu names are allocated.

On the four-phase graph display screen 22, there is provided a POS button 22a to ask for display of the POS analysis data associated with the consumer survey data displayed on this screen. When this POS button 22a is clicked by a pointing device, for example, a POS analysis data display screen such as POS graph display screen 30 is displayed.

Further, on the four-phase graph display screen 22, there are provided a pull-down list 22b for the user to specify a menu name; a “reason” button 22c to ask for display of reason for attention and preference; and a “answerer characteristics” button 22d to ask for answerer's characteristics in question & answer survey.

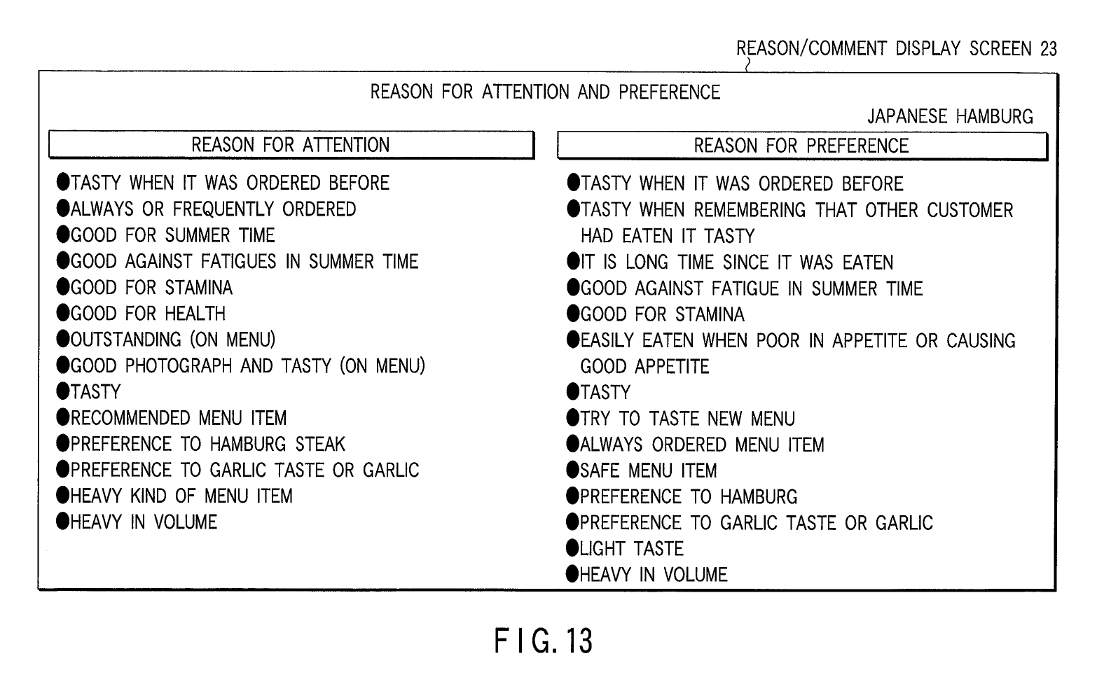

For example, assume that a user who has seen the four-phase graph on this four-phase graph display screen 22 wants to know why the degree of preference of moderate breeze Hamburg steak is high. The user specifies a moderate breeze Hamburg steak on the pull-down list 22b, and presses the “reason” button 22c. Then, the reason comment display screen 23 shown in FIG. 13 is displayed based on the question & answer survey result concerning moderate breeze Hamburg steak.

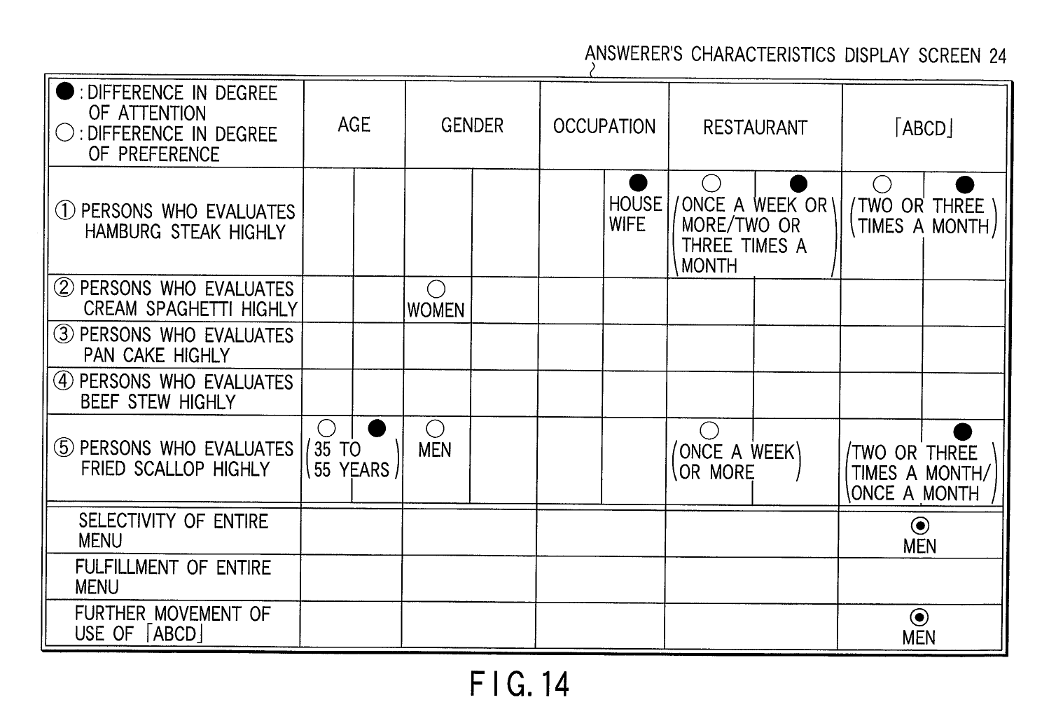

In addition, for example, assume that the user who has seen the four-phase graph on the four-phase graph display screen 22 wants to know the answerer's characteristics in question & answer survey. In this case, the user press the answerer's characteristics” button 22d. Then, the answerer's characteristics display screen 24 shown in FIG. 14 is displayed.

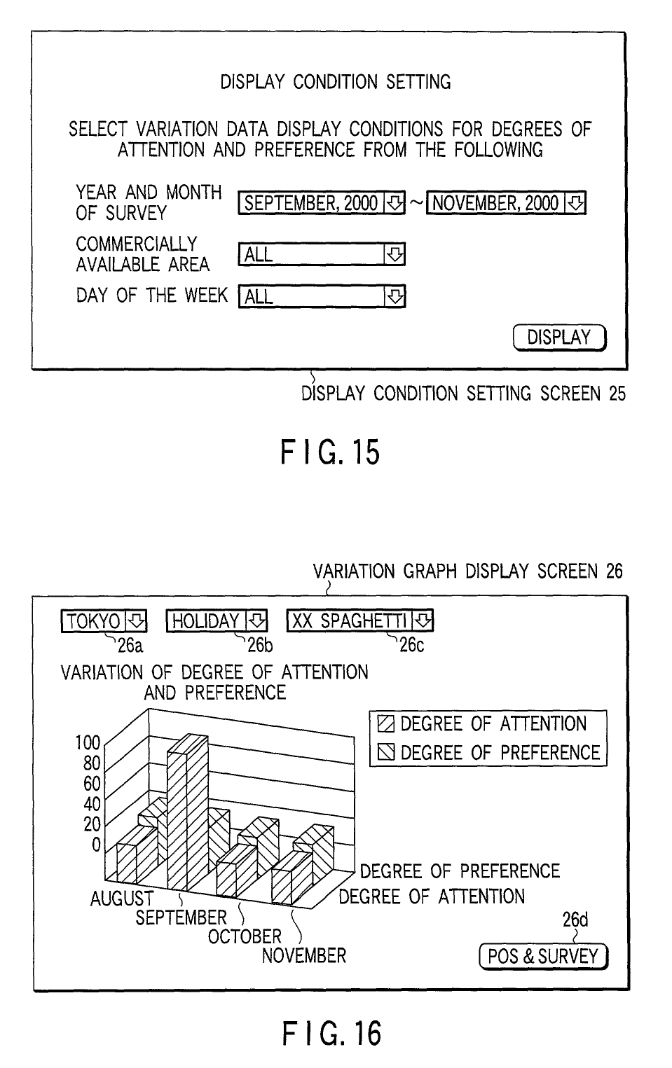

On the other hand, when the user select a display “change in degree of attention and preference” on the consumer survey report top screen 20 shown in FIG. 10, a display condition setting screen 25 shown in FIG. 15 is displayed. The user selects display conditions by using the pull-down list on this display condition setting screen 25. Then, a variation graph display screen 26 as shown in FIG. 26 is displayed in accordance with the display conditions. On this variation graph display screen 26, a graph in which time is defined on a horizontal axis and the degree of attention and preference is defined on a vertical axis is displayed based on consumer survey data.

On the variation graph display screen 26, there are provided pull-down lists 26a to 26c for display condition change. By using these lists, the display conditions can be freely changed.

Further, on the variation graph display screen 26, there is provided a “POS & survey” button 26d to ask whether or not the consumer survey data displayed on this screen and the POS analysis data associated with the data are displayed to be superimposed on each other.

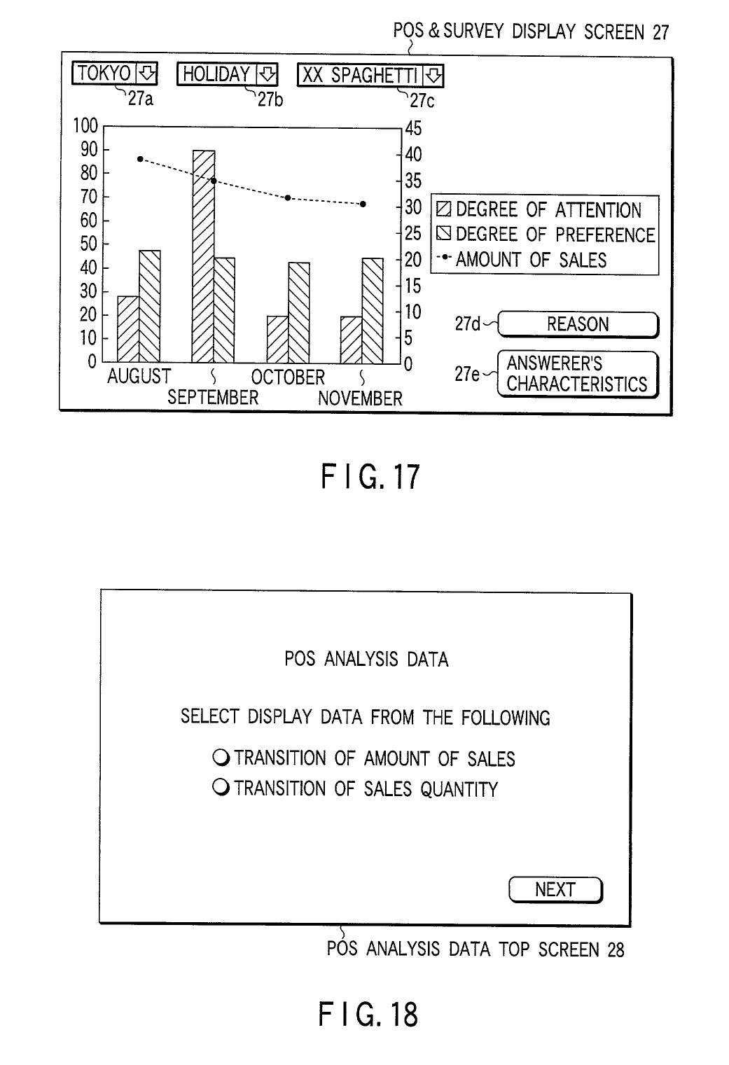

When the user presses this “POS & survey” button 26d, a POS & survey display screen 27 shown in FIG. 17 is displayed. On this POS & survey display screen 27, the mutually associated consumer survey data and a graph for POS analysis data are displayed to be superimposed on each other. In addition, on this POS & survey display screen 27, there are pull-down lists 27a to 27c for display condition change. Further, on the POS & survey display screen 27, there are a “reason” button 27d and a “answerer's characteristics” button 27e. When these buttons are pressed, the above reason comment display screen 23 and answerer's characteristics display screen 24 are displayed, respectively.

Next, assume that the user selects a display “POS analysis data” on the top screen 19 shown in FIG. 9. In this case, the POS analysis data top screen 28 shown in FIG. 18 is displayed. The user specifies either a display “transition of amount of sales” or a display “transition of sales quantity” on this POS analysis data top screen 28.

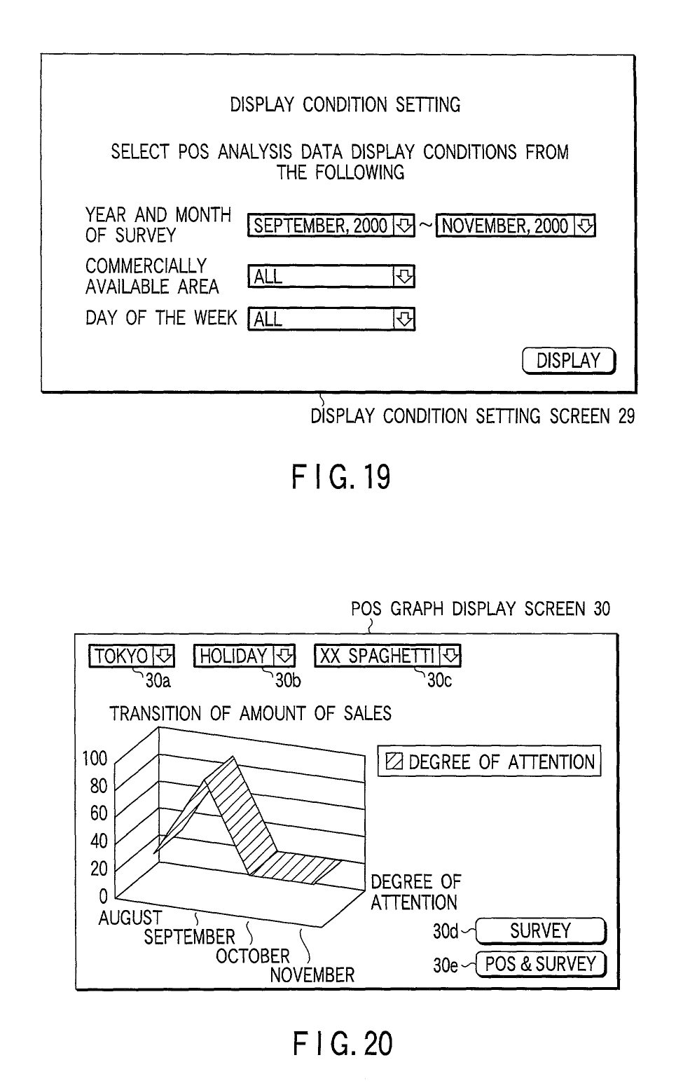

When the user select a display “transition of amount of sales”, a display condition setting screen 29 shown in FIG. 19 is displayed. The user selects display conditions by using a pull-down list on this display condition setting screen 29. Then, a POS graph display screen 30 as shown in FIG. 20 is displayed in accordance with the display conditions.

On this POS graph display screen 30, a graph in which time is defined on a horizontal axis and an amount of sales is defined on a vertical axis is displayed based on the POS analysis data. The display state can be freely changed by using the pull-down lists 30a to 30c for display condition change.

In addition, on the POS graph display screen 30, there is provided a “survey” button 30d to ask for display of the consumer survey data associated with the POS analysis data displayed on this screen. When this “survey” button 30d is displayed, for example, there is displayed a screen for consumer survey data display such as the four-phase graph display screen 22 shown in FIG. 12.

Further, on the POS graph display screen 30, there is provided a “POS & survey” button 30e to ask whether or not the POS analysis data displayed on this screen and the consumer survey data associated with the data are displayed to be superimposed on each other. When the user presses the “POS & survey” button 30e, for example, the POS & survey display screen 27 shown in FIG. 17 is displayed.

In the case where the user selects a display “transition of sales quantity” on the POS analysis data top screen 28 shown in FIG. 18 as well, the screen transition state is similar to the above.

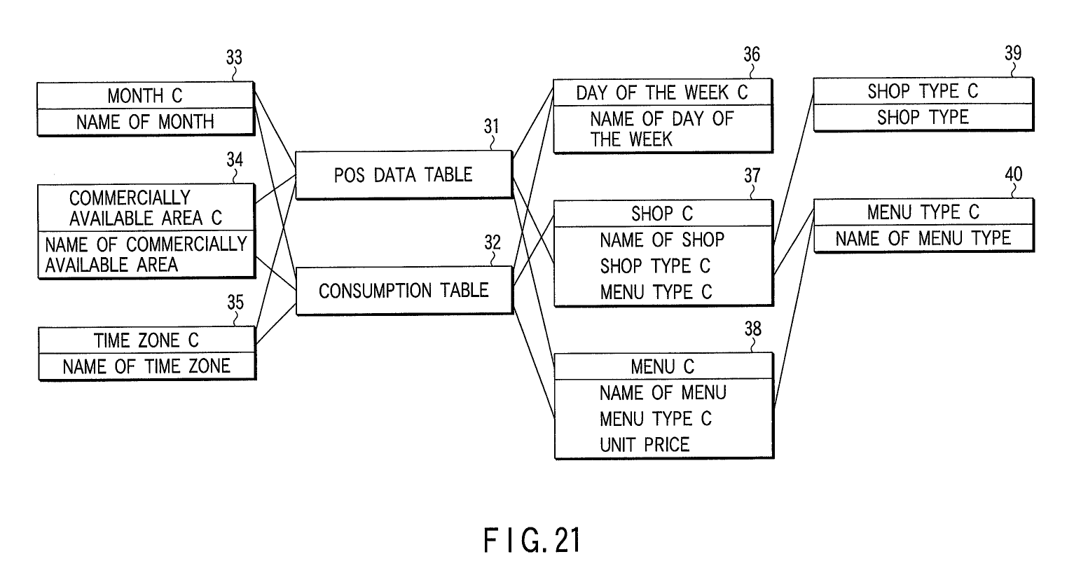

FIG. 21 is a table configuration view of data used in the data analysis system 1. A main table includes a POS data table 31 and a consumer survey table 32. Each of these tables is associated with a month table 33, a commercially available area table 34, a time zone table 35, a day of the weak table 36, a shop table 37, and a menu table 38. The shop table 37 is further associated with a shop type table 39 and a menu type table 40, and the menu table 38 is associated with the menu type table 40.

In this manner, for example, the POS data on a commercially available area can be obtained, and the consumer survey data on a certain time zone can also be acquired. In addition, a variety of analyses can be performed by shop, by day of the week, or by menu.

The transition of the above screen may be achieved on a Web browser.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data analysis method comprising the steps of:
outputting data specified by an initial output specification of at least one item of data for analysis of phenomena and at least one item of data for analysis of causes associated with a state in which the data for analysis of phenomena has been acquired; and
outputting data associated with output data of at least one item of data for analysis of phenomena and at least one item of data for analysis of causes when a user inputs an associated data output specification.

2. A data analysis method comprising the steps of:
outputting data specified by an initial output specification of at least one item of data for analysis of phenomena and at least one item of data for analysis of causes associated with a state in which the data for analysis of phenomena has been acquired;
extracting identification information on data associated with output data, of said at least one item of data for analysis of phenomena and said at least one item of data for analysis of causes, and then outputting a menu configured based on the thus extracted identification information; and
outputting data indicated by identification information specified by a user, of said at least one item of data for analysis of phenomena and said at least one item of data for analysis of causes.

3. A data analysis method according to claim 1, wherein data for analysis of phenomena and data for analysis of causes associated with each other are displayed to be superimposed on each other when they are displayed and output.

4. A data analysis method using a computer system comprising the steps of:
inputting, by a user, a specification of outputting either of at least one item of POS analysis data and at least one item of consumer survey data obtained from a question & answer survey result concerning a state in which the POS analysis data is acquired;
acquiring and outputting specified data of said at least one item of POS analysis data and said at least one item of consumer survey data;
inputting, by a user, a specification of newly outputting data associated with output data; and
acquiring and outputting newly specified data of said at least one item of POS analysis data and said at least one item of consumer survey data.

5. A data analysis method according to claim 4, wherein, in the case where a user inputs a specification of newly outputting data, identification information on data associated with output data is output, thereby assisting user input.

6. A data analysis system comprising:
initial output processing unit for executing a processing for outputting data specified by an initial output specification of at least one item of data for analysis of phenomena and at least one item of data for analysis of causes associated with a state in which the data for analysis of phenomena has been acquired; and
associated output processing unit for, when a user inputs an associated data output specification, executing a processing of outputting data associated with output data, of said at least one item of data for analysis of phenomena and said at least one item of data for analysis of causes.

7. A data analysis system comprising:
initial output processing unit for executing a processing for outputting data specified by an initial output specification of at least one item of data for analysis of phenomena and at least one item of data for analysis of causes associated with a state in which the data for analysis of phenomena has been acquired;
menu output processing unit for executing a processing for extracting identification information on data associated with output data, of said at least one item of data for analysis of phenomena and at least one item of data for analysis of causes, and then, outputting a menu configured based on the thus extracted identification information; and
associated output processing unit for executing a processing for outputting data indicated by identification information specified by a user, of said at least one item of data for analysis of phenomena and said at least one of data for analysis of causes.

8. A data analysis system according to claim 6, wherein said associated output processing unit executes a processing of displaying data for analysis of phenomena and data for analysis of causes associated with each other to be superimposed on each other.

9. A data analysis system comprising:
phenomenon analysis processing unit for acquiring at least one item of data for analysis of phenomena;
cause analysis processing unit for acquiring at least one item of data for analysis of causes, associated with a state in which said data for analysis of phenomena has been acquired;
associated analysis processing unit for obtaining an item associated with contents specified by a user, based on associated information indicating association between said at least one item of data for analysis of phenomena and said at least one item of data for analysis of causes; and
output processing unit for executing a processing for outputting an item associated with contents specified by a user by using said associated analysis processing unit, said phenomenon analysis processing unit, and said cause analysis processing unit.

10. A data analysis system according to claim 9, wherein said output processing unit outputs identification information on an item associated with contents specified by a user, thereby assisting user instruction input.

11. A computer readable recording medium recording a program therein for achieving:
an initial output processing function for executing a processing for outputting data specified by an initial output specification, of at least one item of data for analysis of phenomena and at least one item of data for analysis of causes associated with a state in which the data for analysis of phenomena has been acquired; and
an associated output processing function for executing a processing for outputting data associated with output data, of said at least one item of data for analysis of phenomena and said at leas one item of data for analysis of causes when a user inputs an associated data output specification.

12. A computer readable recording medium recording a program therein for achieving:
an initial output processing function for executing a processing for outputting data specified by an initial output specification, of at least one item of data for analysis of phenomena and at least one item of data for analysis of causes associated with a state in which the data for analysis of phenomena has been acquired;
a menu output processing function for extracting identification information associated with output data, of said at least one item of data for analysis of phenomena and said at least one item of data for analysis of causes, and then, executing a processing of outputting a menu configured based on the thus extracted identification information; and
an associated output processing function for executing a processing for outputting data indicated by identification information specified by a user, of said at least one item of data for analysis of phenomena and said at least one of data for analysis of causes.

13. A computer readable recording medium recording a program therein for achieving:
a phenomenon analysis processing function for acquiring at least one item of data for analysis of phenomena;
a cause analysis processing function for acquiring at least one item of data for analysis of causes, associated with a state in which said data for analysis of phenomena has been acquired;
an associated analysis processing function for obtaining an item associated with contents specified by a user, based on associated information indicating association between said at least one item of data for analysis of phenomena and said at least one item of data for analysis of causes; and
an output processing function for executing a processing for outputting an item associated with contents specified by a user by using said associated analysis processing function, said phenomenon analysis processing function, and said cause analysis processing function.
